(19) United States
(12) Patent Application Publication
(10) Pub. No.: US 2024/0317448 A1
(43) Pub. Date: Sep. 26, 2024

(54) TRAY FOR TRANSFERRING BATTERIES

(71) Applicant: Samsung SDI Co., Ltd., Yongin-si (KR)

(72) Inventor: Sanghun PARK, Yongin-si (KR)

(21) Appl. No.: 18/609,818

(22) Filed: Mar. 19, 2024

(30) Foreign Application Priority Data
Mar. 26, 2023 (KR) 10-2023-0039395
Aug. 1, 2023 (KR) 10-2023-0100643

(51) Int. Cl. B65D 1/36; B65D 21/02; B65D 85/68

(52) U.S. Cl. CPC B65D 1/36; B65D 21/0215; B65D 85/68; B65D 2585/88

(57) ABSTRACT

A battery transfer tray that is stackable in a direction perpendicular to a plane and configured to accommodate batteries is provided. The battery transfer tray includes: a main body plate extending along the plane; an accommodation recess formed downwardly in the direction and including a site portion configured to accommodate a tab of a battery cell; a support portion in a lower surface of the accommodation recess and having a stepped shape; and an protrusion portion on an outer lower end portion of the support portion.

### CROSS-REFERENCE TO RELATED APPLICATIONS

The present application claims priority to and the benefit of Korean Patent Application No. 10-2023-0039395, filed on Mar. 26, 2023, in the Korean Intellectual Property Office, and Korean Patent Application No. 10-2023-0100643, filed on Aug. 1, 2023, in the Korean Intellectual Property Office, the entire disclosures of both of which are incorporated herein by reference.

### BACKGROUND

### 1. Field

Aspects of embodiments of the present disclosure relate to a tray for transferring batteries.

### 2. Description of the Related Art

Generally, secondary batteries are designed to be rechargeable, unlike non-rechargeable (or primary) batteries. Secondary batteries are used as energy sources of devices, such as mobile devices, electric vehicles, hybrid electric vehicles, electric bicycles, and uninterruptible power supplies. Single-cell secondary batteries or multi-cell secondary batteries, which include a plurality of cells connected to each other as one unit, are used according to the types of external devices to which the secondary batteries are applied.

In secondary batteries, tabs, usually formed of thin metal plates, are used to electrically connect cells and safety components to each other. Generally, small tabs are produced and supplied in reel-type packages. The operation of equipment to connect the cells together may be stopped each time such reel-type packages need to be replaced.

### SUMMARY

Embodiments of the present disclosure include a battery transfer tray that is vertically stackable and movable and accommodates components so that separating of the components may be prevented.

Embodiments of the present disclosure include a battery transfer tray that is vertically stackable and accommodate thin-plate components so that adhesion and deformation of the thin-plate components may be prevented.

Additional aspects and features of the present disclosure will be set forth, in part, in the description that follows and, in part, will be apparent from the description or may be learned by practice of the described embodiments.

According to an embodiment of the present disclosure, a battery transfer tray stackable in a direction perpendicular to a plane and configured to accommodate batteries is provided. The battery transfer tray includes: a main body plate extending along the plane; an accommodation recess formed downwardly in the direction and including a site portion configured to accommodate a tab of a battery cell; a support portion in a lower surface of the accommodation recess and having a stepped shape; and an protrusion portion on an outer lower end portion of the support portion.

The battery transfer tray may further include a first inclined portion extending between the main body plate and the site portion.

The support portion may be in a center portion of the lower surface of the accommodation recess, the support portion may include a lower support portion parallel to the site portion and a second inclined portion extending between the site portion and the lower support portion, and the protrusion portion may be on an outer lower end surface of the lower support portion.

The battery transfer tray may further include: a side wall extending from an outer periphery of the main body plate; and a step-shaped stopper on an end portion of the side wall and including a flat portion and an stopper end.

The main body plate may include a plurality of the accommodation recesses.

When a plurality of the battery transfer trays are stacked on each other in the direction, the support portions respectively on the plurality of battery transfer trays may be arranged corresponding to each other.

When a plurality of the battery transfer trays are vertically stacked on each other, the protrusion portion of an upper one of the battery transfer trays and the site portion of a lower one of the battery transfer trays may be spaced apart from each other by a distance.

A thickness of the protrusion portion may be less than half a thickness of the lower support portion.

The protrusion portion may have a hemispherical shape.

The protrusion portion may have a cylindrical shape.

The protrusion portion may have a tapered shape.

The protrusion portion may be formed by embossing the lower support portion.

The protrusion portion may include a plurality of the protrusion portions arranged in a line on the outer lower end portion of the support portion.

The protrusion portion may include a plurality of the protrusion portions arranged in a plurality of rows on the outer lower end portion of the support portion.

An inner width of an end of the support portion connected to the accommodation recess may be less than an outer width of another end of the support portion.

When a plurality of the battery transfer trays are vertically stacked on each other, a conductive plate may be between the protrusion portion of an upper one of the battery transfer trays and the site portion of a lower one of the battery transfer trays.

### BRIEF DESCRIPTION OF THE DRAWINGS

The above and other aspects and features of embodiments of the present disclosure will be more apparent from the following description taken in conjunction with the accompanying drawings, in which:

FIG. 1 is a perspective view of a battery transfer tray according to an embodiment;

FIG. 2 is a plan view of the battery transfer tray shown in FIG. 1;

FIG. 3 is a cross-sectional view taken along the line A-A of FIG. 2;

FIG. 4 is a view of a plurality of battery transfer trays vertically stacked on each other according to an embodiment;

FIG. 5 is an enlarged view of a portion of FIG. 4;

FIG. 6 is a cross-sectional view a battery transfer tray according to a comparative embodiment;

FIGS. 7A and 7B are views of a plurality of battery transfer trays vertically stacked on each other according to a comparative embodiment;

FIG. 8 is an enlarged cross-sectional view of a portion of a battery transfer tray including a hemispherical protrusion portion according to an embodiment;

FIG. 9 is a partial bottom view of the battery transfer tray shown in FIGS. 1 and 2;

FIG. 10 is an enlarged cross-sectional view of a portion of a battery transfer tray including a cylindrical protrusion portion according to an embodiment;

FIG. 11 is an enlarged cross-sectional view of a portion of a battery transfer tray including a tapered protrusion portion according to an embodiment;

FIG. 12 is an enlarged cross-sectional view of a portion of a battery transfer tray including an embossed protrusion portion according to an embodiment; and

FIG. 13 is an enlarged cross-sectional view of a portion of a battery transfer tray including a plurality of protrusion portions according to an embodiment.

### DETAILED DESCRIPTION

Reference will now be made, in detail, to embodiments, examples of which are illustrated in the accompanying drawings. In this regard, the described embodiments may have different forms and should not be construed as being limited to the descriptions set forth herein. Accordingly, embodiments are merely described below, by referring to the figures, to explain aspects and features of the present description.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Hereinafter, embodiments of the present disclosure will be described with reference to the accompanying drawings.

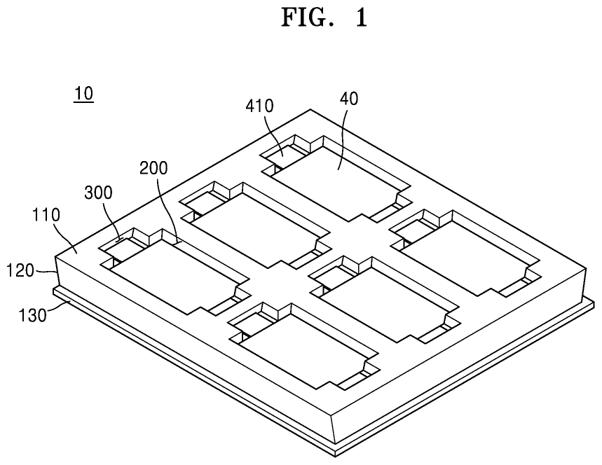

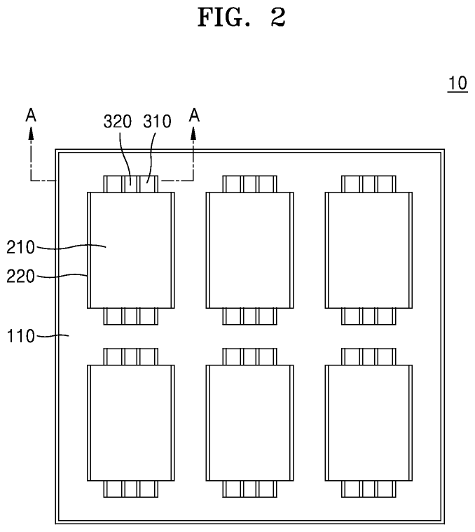

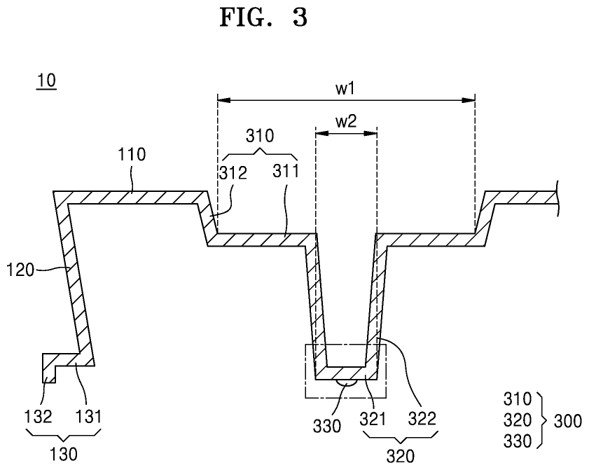

FIG. 1 is a perspective view of a battery transfer tray 10 according to an embodiment, FIG. 2 is a plan view of the battery transfer tray 10 according to an embodiment, and FIG. 3 is a cross-sectional view taken along the line A-A of FIG. 2.

Referring to FIGS. 1 and 2, the battery transfer tray 10 may include a main body plate 110 extending along a plane, battery cell accommodation recess portions 200, and electrode tab accommodation portions 300.

According to an embodiment, the main body plate 110 of the battery transfer tray 10 may include (or may be) a plate-shaped frame. The main body plate 110 may form a main body of the battery transfer tray 10, and the battery cell accommodation recess portions 200 and the electrode tab accommodation portions 300 may be arranged on a plane of the main body plate 110. The main body plate 110 may include a flat plate having a certain degree of rigidity. For example, the main body plate 110 may include a tetragonal plate extending along the plane of the main body plate 110 and may have rigidity sufficient to support battery cells 40 arranged in the battery cell accommodation recess portions 200 and the electrode tab accommodation portions 300.

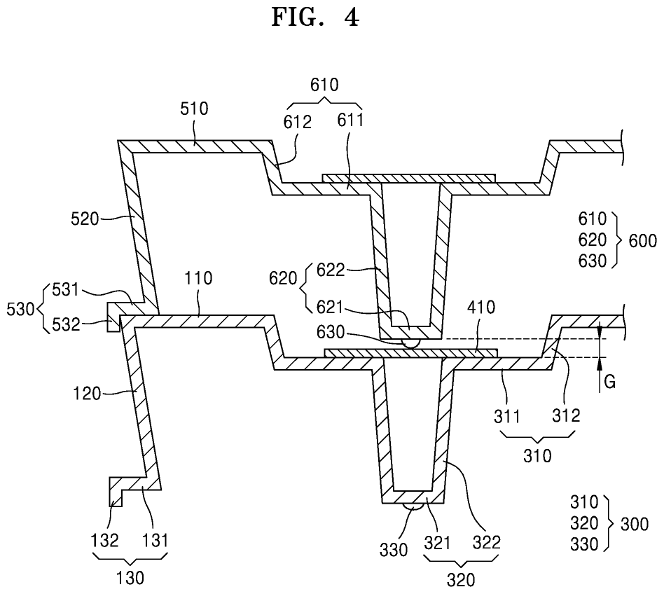

Referring to FIGS. 1 and 3, side walls 120 may be provided along an outer periphery of the main body plate 110. In an embodiment, the side walls 120 may extend downwardly from the outer periphery of the main body plate 110. The side walls 120 may support the battery transfer tray 10 in a vertical direction. Ends of the side walls 120 may be connected to the main body plate 110, and other ends of the side walls 120 may be connected to a stopper 130. In an embodiment, the side walls 120 may be inclined at an angle (e.g., a predetermined angle) with respect to a direction perpendicular to the plane of the main body plate 110. In the battery transfer tray 10 shown in FIG. 1, for example, a side wall 120 located on the left side of the main body plate 110 may extend at an angle to the right (e.g., an acute angle may be formed between the side wall 120 and the main body plate 110), and a side wall 120 located on the right side of the main body plate 110 may extend at an angle to the left. Therefore, in a state in which battery transfer trays 10 are stacked, the stopper 130 located at an upper side may be mounted on the outer periphery of a main body plate 110 located at a lower side. The height of the side walls 120 may determine a vertical distance between battery transfer trays 10 that are vertically stacked. Stacking of the battery transfer trays 10 is described later with reference to FIG. 4.

The stopper 130 may be provided on the other ends (e.g., the distal ends) of the side walls 120. The stopper 130 may maintain the state of battery transfer trays 10 that are vertically stacked. In one embodiment, the stopper 130 may adjust (or may control) a stacking distance such that, when the battery transfer trays 10 are vertically stacked, upper and lower battery transfer trays 10 may maintain a vertical distance (e.g., a predetermined vertical distance) therebetween. In one embodiment, the stopper 130 may be provided on the other ends of the side walls 120, and thus, when battery transfer trays 10 are vertically stacked, the stopper 130 may prevent the battery transfer trays 10 from moving forward, backward, left, and right and may, thus, prevent the battery transfer trays 10 from separating from each other.

The stopper 130 may have a stepped shape. In an embodiment, the stopper 130 may have a stepped shape including a flat portion 131 and an stopper end 132.

An end of the flat portion 131 may be connected to the side walls 120, and the other end of the flat portion 131 may be connected to the stopper end 132 and parallel to the main body plate 110. In an embodiment, when battery transfer trays 10 are vertically stacked, the flat portion 131 of an upper battery transfer tray 10 may be in contact with an upper surface of the main body plate 110 of a lower battery transfer tray 10 and may, thus, support the upper battery transfer tray 10.

The stopper end 132 may extend downwardly from the other end of the flat portion 131. In an embodiment, when battery transfer trays 10 are stacked vertically, the stopper end 132 of an upper battery transfer tray 10 may be positioned on the 1 outer periphery of the main body plate 110 of a lower battery transfer tray 10. For example, in a state in which battery transfer trays 10 are vertically stacked, the stopper end 132 of an upper battery transfer tray 10 may surround (or may extend along) the outer periphery of the main body plate 110 and portions of the side walls 120 of a lower battery transfer tray 10. Therefore, battery transfer trays 10 that are stacked may be prevented from moving stopper, downward, forward, and backward relative to each other. The stacking state of the battery transfer trays 10 is described later with reference to FIG. 4.

Referring to FIGS. 1 and 2, according to an embodiment, the battery transfer tray 10 may include the battery cell accommodation recess portions 200. In an embodiment, the battery cell accommodation recess portions 200 may have a stepped shape formed by downwardly recessing the plane of the main body plate 110. The battery cell accommodation recess portions 200 may be configured to accommodate main bodies of the battery cells 40 therein and may support the main bodies of the battery cells 40.

In an embodiment, the battery cell accommodation recess portions 200 may include battery cell site portions 210 and inclined portions 220.

The battery cell site portions 210 may be parallel to the main body plate 110 to support the main bodies of the battery cells 40. In an embodiment, the battery cell site portions 210 may have a shape and size corresponding to the main bodies of the battery cells 40. For example, the battery cell site portions 210 may have a tetragonal shape corresponding to the size of the main bodies of the battery cells 40, and thus, when the battery cells 40 are placed in the battery cell accommodation recess portions 200, the battery cell site portions 210 may support the main bodies of the battery cells 40.

The inclined portions 220 may connect the battery cell site portions 210 to the main body plate 110. For example, as shown in FIGS. 1 and 2, the inclined portions 220 may connect (or may extend between) left and right sides of the battery cell site portions 210 to the main body plate 110. In an embodiment, the inclined portions 220 may have a height (e.g., a predetermined height) between the main body plate 110 and the battery cell site portions 210. For example, the inclined portions 220 may have a height that is greater than the thickness of the main bodies of the battery cells 40 between the main body plate 110 and the battery cell site portions 210, and thus, when the main bodies of the battery cells 40 are placed on the battery cell site portions 210, the main bodies of the battery cells 40 may not protrude above the plane of the main body plate 110.

In an embodiment, the inclined portions 220 may be inclined at an angle (e.g., a predetermined angle) with respect to a direction perpendicular to the plane of the main body plate 110. For example, the inclined portions 220 may be inclined at an angle such that the inclined portions 220 may be closer to the centers of the battery cell site portions 210 in a downward direction. Therefore, the battery cells 40 may be easily inserted into or removed from the battery cell accommodation recess portions 200 formed in the main body plate 110.

Although FIGS. 1 and 2 illustrate an embodiment including six tetragonal battery cell accommodation recess portions 200 in the main body plate 110, the present disclosure is not limited thereto, and one or more battery cell accommodation recess portions 200 having various shapes depending on the shapes of the battery cells 40 may be provided in the main body plate 110.

Referring to FIGS. 1 to 3, in an embodiment, the battery transfer tray 10 may include the electrode tab accommodation portions 300. The electrode tab accommodation portions 300 may be provided adjacent to the battery cell accommodation recess portions 200 and may be configured to accommodate electrode tabs 410 of the battery cells 40. For example, when one electrode tab 410 is provided on each of both sides (e.g., opposite sides) of each of the battery cells 40, the electrode tab accommodation portions 300 may also be provided on both sides (e.g., opposite sides) of the battery cell accommodation recess portions 200. Although FIGS. 1 and 2 illustrate an embodiment in which the electrode tab accommodation portions 300 are provided on both sides of the battery cell accommodation recess portions 200, the present disclosure is not limited thereto. One or more electrode tab receiving portions 300 may be provided on the main body plate 110 according to the number and positions of electrode tabs 410 of the battery cells 40.

In an embodiment, the electrode tab accommodation portions 300 may include accommodation recesses 310, support portions 320, and protrusion portions 330.

The accommodation recesses 310 may be configured to support the electrode tabs 410 when the battery cells 40 are placed in the battery cell accommodation recess portions 200. In an embodiment, the accommodation recesses 310 may be formed by downwardly recessing the plane of the main body plate 110. The accommodation recesses 310 may be provided in the main body plate 110 at positions adjacent to the battery cell accommodation recess portions 200.

In an embodiment, the accommodation recesses 310 may include site portions 311 and first inclined portions 312.

The site portions 311 may form planes for supporting the electrode tabs 410. In an embodiment, the site portions 311 may be downwardly recessed in a direction perpendicular to the plane of the main body plate 110. The site portions 311 may be parallel to the main body plate 110 to support the electrode tabs 410. For example, when the battery cells 40 are placed in the battery cell accommodation recess portions 200, the electrode tabs 410 of the battery cells 40 may be placed and supported on the planes of the site portions 311.

The first inclined portions 312 may connect (or may extend between) the main body plate 110 and the site portions 311 to each other. The first inclined portions 312 may have a height (e.g., a predetermined between the main body plate 110 and the site portions 311. For example, the height of the first inclined portions 312 may be determined such that the electrode tabs 410 provided on the battery cells 40 may be supported by the site portions 311 in a state in which the battery cells 40 are placed in the battery cell accommodation recess portions 200. Therefore, the site portions 311 may be provided at a height that is different from the height of the battery cell site portions 210. In an embodiment, the first inclined portions 312 may be inclined at an angle with respect to a direction perpendicular to the plane of the main body plate 110. For example, the first inclined portions 312 may be inclined at an angle (e.g., a predetermined angle) such that the first inclined portions 312 may be closer to the centers of the site portions 311 in a downward direction.

The support portions 320 may be connected to the accommodation recesses 310 and may act as vertical support structures for the accommodation recesses 310. In an embodiment, the support portions 320 may have a stepped shape and may be provided on lower surfaces of the accommodation recesses 310. The support portions 320 may be recessed downwardly from central portions of the lower surfaces of the accommodation recesses 310, that is, from center portions of the site portions 311.

In an embodiment, the support portions 320 may include lower support portions 321 and second inclined portions 322.

The lower support portions 321 may form lower portions of the support portions 320. In an embodiment, the lower support portions 321 may be recessed downwardly in a direction perpendicular to the site portions 311 and may be parallel to the site portions 311. The width w2 of the lower support portions 321 may be less than the width w1 of the site portions 311.

The second inclined portions 322 may connect (or may extend between) the site portions 311 and the lower support portions 321 to each other. The second inclined portions 322 may have a height (e.g., a predetermined height) between the lower support portions 321 and the site portions 311. The height of the second inclined portions 322 may be determined according to a distance between the lower support portions 321 of a lower battery transfer tray 10 and the site portions 311 of an upper battery transfer tray 10 in the vertical stack of battery transfer trays 10.

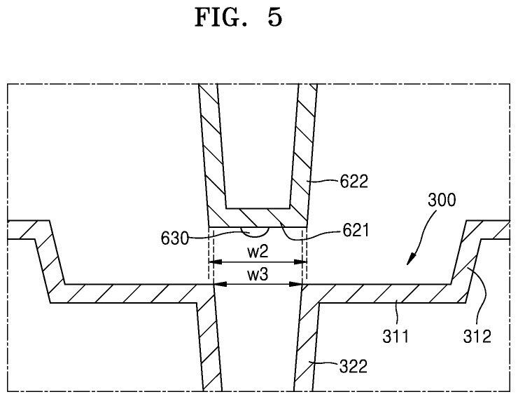

In an embodiment, the second inclined portions 322 may be inclined at an angle (e.g., a predetermined angle) with respect to a direction perpendicular to the plane of the main body plate 110. For example, the second inclined portions 322 may be inclined at an angle such that the second inclined portions 322 may be closer to the centers of the lower support portions 321 in a downward direction. For example, the second inclined portions 322 may be inclined at an angle such that an inner width w3 of ends of the support portions 320 connected to the accommodation recesses 310 may be less than an outer width w2 of the other ends of the support portions 320 connected to the accommodation recesses 310 (see, e.g., FIG. 5).

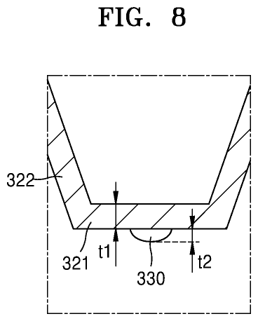

The protrusion portions 330 may be provided on outer lower end portions of the support portions 320. In an embodiment, the protrusion portions 330 may protrude from lower surfaces of the lower support portions 321. For example, the protrusion portions 330 may be provided on the lower support portions 321 to stably support the electrode tabs 410 disposed between battery transfer trays 10 that are vertically stacked. The shape and arrangement of the protrusion portions 330 are described later with reference to FIGS. 8 to 13.

FIG. 4 is a view illustrating a state in which the battery transfer trays 10 are vertically stacked according to an embodiment, and FIG. 5 is an enlarged view of a portion of FIG. 4 without showing the electrode tab 410.

Referring to FIGS. 4 and 5, the battery transfer trays 10 may be stacked in a direction perpendicular to the planes of main body plates 110 and 510. According to an embodiment, when the battery transfer trays 10 are vertically stacked, a stopper 530 of an upper battery transfer tray 10 may be coupled to an outer periphery of a main body plate 110 of a lower battery transfer tray 10. For example, side walls 520 of the upper battery transfer tray 10 may be inclined at an angle (e.g., an acute angle) toward the center of the upper battery transfer tray 10, a flat portion 531 of the stopper 530 may be in contact with an upper surface of the main body plate 110 of the lower battery transfer tray 10, and an stopper end 532 may cover (e.g., may partially cover) the outer periphery of the main body plate 110 and side walls 120 of the lower battery transfer tray 10. Therefore, the upper battery transfer tray 10 and the lower battery transfer tray 10 may be vertically spaced apart from each other by a distance corresponding to the heights of the side walls 120 and 520.

When the battery transfer trays 10 are vertically stacked, an electrode tab accommodation portion 600 of the upper battery transfer tray 10 may be positioned corresponding to an electrode tab accommodation portion 300 of the lower battery transfer tray 10. For example, an accommodation recess 310 of the lower battery transfer tray 10 may be positioned under (e.g., may be vertically aligned with) an accommodation recess 610 of the upper battery transfer tray 10, and a support portion 320 of the lower battery transfer tray 10 may be positioned under a support portion 620 of the upper battery transfer tray 10.

When the battery transfer trays 10 are vertically stacked, a gap G may be formed between a lower support portion 621 of the upper battery transfer tray 10 and a site portion 311 of the lower battery transfer tray 10. When the battery transfer trays 10 are vertically stacked, the gap G may be formed to stably support an electrode tab 410 disposed on the site portion 311. In an embodiment, the electrode tab 410 disposed on the site portion 311 may include a thin plate material. For example, the electrode tab 410 may include a thin conductive plate. If the gap G is too small, the electrode tab 410 may adhere or deform between the upper and lower battery transfer trays 10, and if the gap G is too large, the electrode tab 410 may be separated from the upper and lower battery transfer trays 10. Therefore, the gap G may have a size (e.g., a predetermined size) to prevent adhesion, deformation, and separation of the electrode tab 410.

In an embodiment, the gap G may be determined by a first inclined portion 312 and a second inclined portion 322. When the battery transfer trays 10 are vertically stacked, the upper battery transfer tray 10 and the lower battery transfer tray 10 may be vertically spaced apart from each other by the height of the side walls 120, as described above, and the electrode tab accommodation portion 300 may protrude downwardly by the height of the first inclined portion 312 and the second inclined portion 322. For example, the accommodation recess 610 of the upper battery transfer tray 10 may include a site portion 611 protruding downwardly from the main body plate 510 by the height of a first inclined portion 612 and the lower support portion 621 protruding downwardly from the site portion 611 by the height of the second inclined portion 622. In such an embodiment, the gap G may be formed between a lower surface of the lower support portion 621 of the upper battery transfer tray 10 and the site portion 311 of the lower battery transfer tray 10.

When the battery transfer trays 10 are vertically stacked, an protrusion portion 330 provided on a lower support portion 321 may face the electrode tab 410. For example, when the battery transfer trays 10 are vertically stacked, the site portion 311 of the lower battery transfer tray 10 may face an protrusion portion 630 of the upper battery transfer tray 10. In such an embodiment, if the electrode tab 410 is placed on the site portion 311 of the lower battery transfer tray 10, the electrode tab 410 and the protrusion portion 630 of the upper battery transfer tray 10 may be brought in contact with each other or may be spaced apart from each other by a distance (e.g., a predetermined distance). For example, if the electrode tab 410 placed on the lower battery transfer tray 10 is brought into contact with the protrusion portion 630 of the upper battery transfer tray 10, the electrode tab 410 may have a smaller contact area than if the electrode tab 410 were brought into contact with the lower support portion 621. For example, if the electrode tab 410 placed on the lower upper battery transfer tray 10 is spaced apart from the protrusion portion 630 of the upper battery transfer tray 10 by a distance, the distance may be less than the thickness of the electrode tab 410, and the electrode tab 410 may not be separated from the upper and lower battery transfer trays 10 even though the upper and lower battery transfer trays 10 are moved in a stacked state.

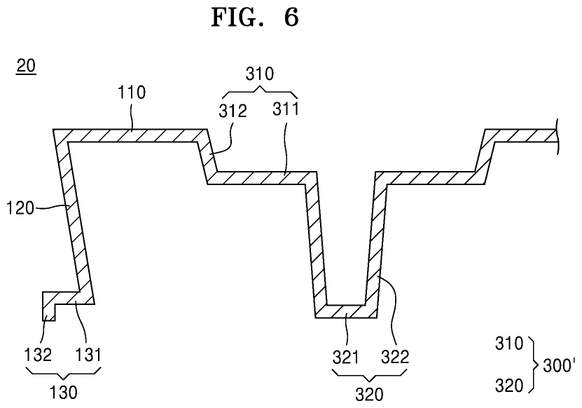

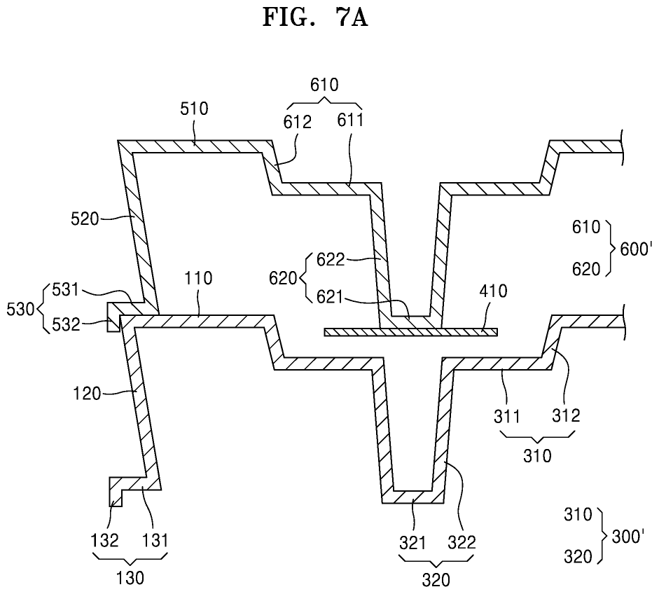

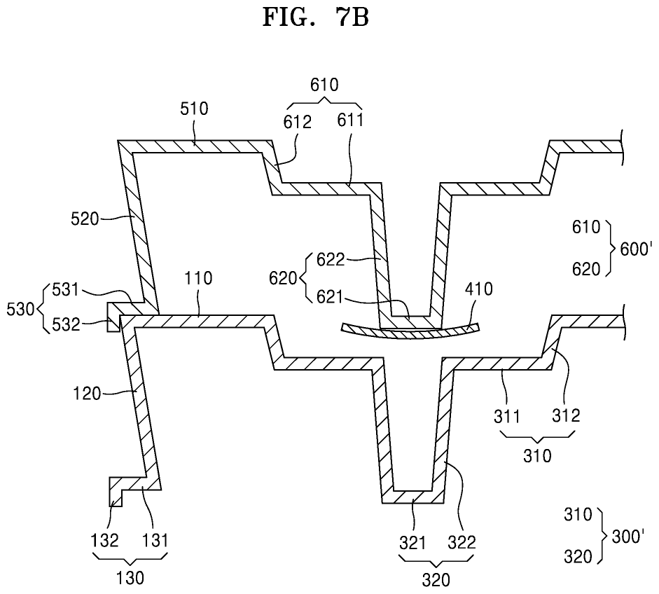

FIG. 6 is a cross-sectional view of a battery transfer tray 20 according to a comparative embodiment that omits an protrusion portion 330 (refer to FIG. 3) on a lower end of a support portion 320, and FIGS. 7A and 7B are views illustrating a state in which battery transfer trays 20 according to a comparative embodiment omitting an protrusion portions 630 and 330 (refer to FIG. 4) on lower ends of support portions 620 and 320 are vertically stacked. In detail, in FIGS. 6 to 7B, the same reference numerals as in FIGS. 3 and 4 indicate the same components, and the description already given thereof may be referred to in FIGS. 3 and 4. In the comparative embodiment, the electrode tab accommodation portions 300′ and 600′ may include accommodation recesses 310 and 610 and support portions 320 and 620.

In a case where the battery transfer trays 20 do not include protrusion portions 330 on lower support portions 321 as shown in, for example FIG. 6, if the battery transfer trays 20 are vertically stacked, an electrode tab 410 placed on a lower battery transfer tray 20 may come into contact with and adhere to the lower support portion 621 of an upper battery transfer tray 20, as shown in, for example, FIG. 7A, or may come into contact with the lower support portion 621 of the upper battery transfer tray 20 and deform, as shown in, for example, FIG. 7B.

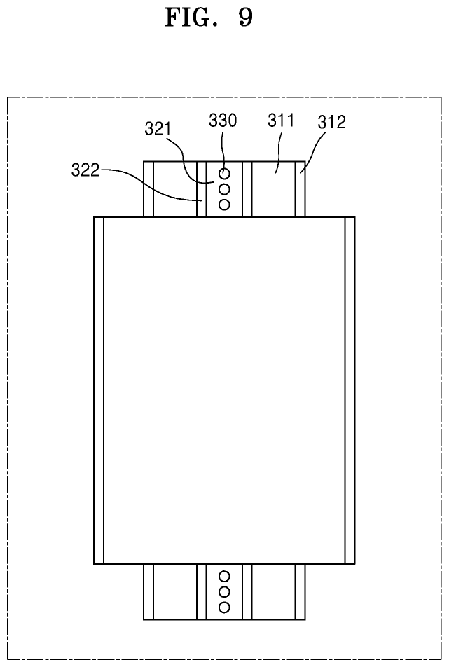

FIG. 8 is an enlarged cross-sectional view of a portion of a battery transfer tray 10 including a hemispherical protrusion portion 330 according to an embodiment, and FIG. 9 is a partial bottom view of the battery transfer tray 10 shown in FIG. 2.

Referring to FIGS. 3 to 5, 8, and 9, the protrusion portion 330 may be provided on a central portion of the lower support portion 321. For example, a plurality of protrusion portions 330 may be arranged in a row on the central portion of the lower support portion 321. In an embodiment, the thickness t2 of the protrusion portion 330 may be less than half the thickness t1 of the lower support portion 321.

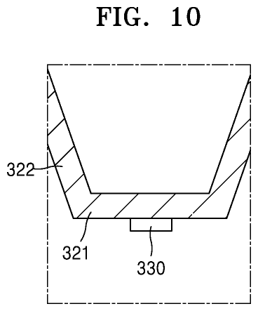

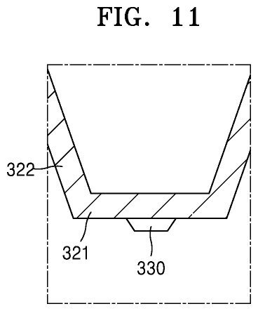

FIG. 10 is an enlarged cross-sectional view of a portion of a battery transfer tray 10 including a cylindrical protrusion portion 330 according to an embodiment, and FIG. 11 is an enlarged cross-sectional view of a portion of a battery transfer tray 10 including a tapered protrusion portion 330 according to an embodiment.

Referring to FIGS. 8, 10, and 11, the protrusion portions 330 may have various shapes. In an embodiment, the hemispherical protrusion portion 330 may be provided as shown in FIG. 8. For example, the hemispherical protrusion portion 330 may have a vertically-pressed hemispherical shape. In an embodiment, the cylindrical protrusion portion 330 may be provided as shown in FIG. 10 or the tapered protrusion portion 330 may be provided as shown in FIG. 11. For example, each of the protrusion portions 330 having various shapes may have a thickness t2 that is less than half the thickness t1 of the lower support portion 321.

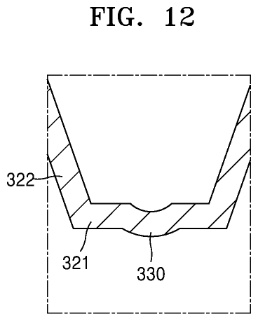

FIG. 12 is an enlarged cross-sectional view of a portion of a battery transfer tray 10 including an embossed protrusion portion 330 according to an embodiment.

Referring to FIG. 12, the embossed protrusion portion 330 may be formed by embossing (e.g., pressing or punching) a lower support portion 321. The protrusion portions 330 shown in FIGS. 8, 10, and 11 protrude from the lower support portions 321, and thus, positions at where the protrusion portions 330 are provided may be relatively thick because the thickness of the protrusion portions 330 and the thickness of the lower support portions 321 are added. In another embodiment, the embossed protrusion portion 330 may be formed by partially embossing the lower support portion 321, and thus, the embossed protrusion portion 330 and the lower support portion 321 may have the same thickness as the lower support portion 321.

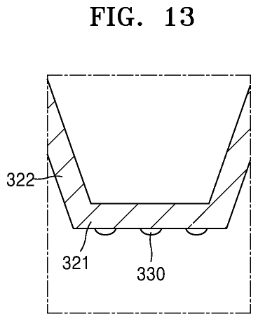

FIG. 13 is an enlarged cross-sectional view of a portion of a battery transfer tray 10 including a plurality of protrusion portions 330 according to an embodiment.

Referring to FIG. 13, the protrusion portions 330 may be arranged in a plurality of rows on an outer lower end portion of a support portion 320. In an embodiment, the protrusion portions 330 may be arranged in a plurality of rows and may protrude from a lower surface of a lower support portion 321. The protrusion portions 330 may be symmetrically arranged in a plurality of rows on the lower surface of the lower support portion 321. For example, as shown in FIG. 13, the protrusion portions 330 may be arranged in three rows on the lower support portion 321. In such an embodiment, a middle row may be on a central portion of the lower support portion 321, and the other two rows may be symmetrical with respect to the middle row.

In the battery transfer tray 10 according to embodiments, one or more protrusion portions 330 are arranged on the outer lower end portion of the support portion 320, and thus, when a plurality of battery transfer trays 10 are vertically stacked, an electrode tab 410, which is a thin plate member, may be safely maintained without adhesion or deformation.

According to an embodiment, when the battery transfer trays 10 are vertically stacked, the contact area between an electrode tab 410 and the protrusion portions 330 may be relatively small, thereby reducing a reaction that may be caused by oil on the electrode tab 410 or oil used to manufacture the battery transfer trays 10. For example, the battery transfer tray 10 including the protrusion portions 330 on a lower surface of the support portion 320 may have a relatively small contact area between an electrode tab 410 and the protrusion portion(s) 330, and thus, adhesion between the battery transfer tray 10 and the electrode tab 410 may be prevented.

In the battery transfer tray 10 according to embodiments, an electrode tab accommodation portion 300 configured to accommodate an electrode tab 410 may include the protrusion portions 330 on the outer lower end portion of the support portion 320. However, this is a non-limiting example. For example, aspects of the described embodiments may be applied to trays that are vertically stackable and configured to transfer thin plate members besides electrode tabs 410. In this case, the trays may not include battery cell accommodation recess portions 200 but may include accommodation portions corresponding to the electrode tab accommodation portions 300 including the protrusion portions 330. The positions and shapes of the accommodation portions of the trays may be variously modified according to the shapes of thin plate members to be transferred.

To aid in understanding the present disclosure, reference numerals are used in the embodiments shown in the drawings and specific terms are used to describe the embodiments of the present disclosure; however, these reference numerals and terms are not intended to limit the scope of the present disclosure and may represent all the components that could be considered by those skilled in the art.

Specific executions described herein are merely examples and do not limit the scope of the present disclosure in any way. For simplicity of description, other functional aspects of conventional electronic configurations, control systems, software, and the systems may be omitted. Furthermore, line connections or connection members between elements depicted in the drawings represent functional connections and/or physical or circuit connections by way of example, and in actual applications, they may be replaced or embodied as various additional functional connections, physical connections, or circuit connections. Also, the described elements may not be inevitably required elements for the application of the present disclosure unless they are specifically mentioned as being “essential” or “critical.” Expressions such as “including” and “provided with” are used to be understood as open-ended terminology.

The singular forms “a,” “an” and “the” in this present disclosure, in particular, claims, may be intended to include the plural forms as well. Unless otherwise defined, the ranges defined herein are intended to include any embodiment to which values within the range are individually applied and may be considered to be the same as individual values constituting the range in the detailed description. Finally, operations constituting the method of the present disclosure may be performed in appropriate order unless explicitly described in terms of order or described to the contrary. The present disclosure is not necessarily limited to the order of operations given in the description. The examples or exemplary terms (for example, etc.) used herein are to merely describe embodiments in detail and not intended to limit the present disclosure unless defined by the following claims. Also, those skilled in the art will readily appreciate that various modifications and changes may be made within the scope of the present disclosure.

As described above, according to the above-described embodiments, protrusion portions protrude from the lower ends of the support portions of the battery transfer trays that are vertically stackable while accommodating thin plate members. Thus, when the battery transfer trays are vertically stacked, components arranged in the accommodation recesses of a lower battery transfer tray may not adhere to the lower ends of the support portions of an upper battery transfer tray and may be safely maintained in position.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as defined by the following claims and their equivalents.

What is claimed is:

1. A battery transfer tray stackable in a direction perpendicular to a plane and configured to accommodate batteries, the battery transfer tray comprising:
a main body plate extending along the plane;
an accommodation recess formed downwardly in the direction and comprising a site portion configured to accommodate a tab of a battery cell;
a support portion in a lower surface of the accommodation recess and having a stepped shape; and
an protrusion portion on an outer lower end portion of the support portion.

2. The battery transfer tray as claimed in claim 1, further comprising a first inclined portion extending between the main body plate and the site portion.

3. The battery transfer tray as claimed in claim 1, wherein the support portion is in a center portion of the lower surface of the accommodation recess,
wherein the support portion comprises a lower support portion parallel to the site portion and a second inclined portion extending between the site portion and the lower support portion, and
wherein the protrusion portion is on an outer lower end surface of the lower support portion.

4. The battery transfer tray as claimed in claim 1, further comprising:
a side wall extending from an outer periphery of the main body plate; and
a step-shaped stopper on an end portion of the side wall and comprising a flat portion and an stopper end.

5. The battery transfer tray as claimed in claim 1, wherein the main body plate comprises a plurality of the accommodation recesses.

6. The battery transfer tray as claimed in claim 1, wherein, when a plurality of the battery transfer trays are stacked on each other in the direction, the support portions respectively on the plurality of battery transfer trays are arranged corresponding to each other.

7. The battery transfer tray as claimed in claim 1, wherein, when a plurality of the battery transfer trays are vertically stacked on each other, the protrusion portion of an upper one of the battery transfer trays and the site portion of a lower one of the battery transfer trays are spaced apart from each other by a distance.

8. The battery transfer tray as claimed in claim 3, wherein a thickness of the protrusion portion is less than half a thickness of the lower support portion.

9. The battery transfer tray as claimed in claim 1, wherein the protrusion portion has a hemispherical shape.

10. The battery transfer tray as claimed in claim 1, wherein the protrusion portion has a cylindrical shape.

11. The battery transfer tray as claimed in claim 1, wherein the protrusion portion has a tapered shape.

12. The battery transfer tray as claimed in claim 3, wherein the protrusion portion is formed by embossing the lower support portion.

13. The battery transfer tray as claimed in claim 1, wherein the protrusion portion comprises a plurality of the protrusion portions arranged in a line on the outer lower end portion of the support portion.

14. The battery transfer tray as claimed in claim 1, wherein the protrusion portion comprises a plurality of the protrusion portions arranged in a plurality of rows on the outer lower end portion of the support portion.

15. The battery transfer tray as claimed in claim 1, wherein an inner width of an end of the support portion connected to the accommodation recess is less than an outer width of another end of the support portion.

16. The battery transfer tray as claimed in claim 1, wherein, when a plurality of the battery transfer trays are vertically stacked on each other, a conductive plate is between the protrusion portion of an upper one of the battery transfer trays and the site portion of a lower one of the battery transfer trays.
